(19) United States
(12) Patent Application Publication
(10) Pub. No.: US 2022/0147717 A1
(43) Pub. Date: May 12, 2022

(54) AUTOMATIC IDENTIFYING SYSTEM AND METHOD

(71) Applicant: SIGMA RATINGS, INC., New York, NY (US)

(72) Inventors: Robert JONES, Jr., New York, NY (US); Gabrielle HADDAD, New York, NY (US); Niger LITTLE-POOLE, Brooklyn, NY (US); Ryan BEPPEL, Brooklyn, NY (US); Cole PAGE, Brooklyn, NY (US)

(21) Appl. No.: 17/433,854

(22) PCT Filed: Feb. 27, 2020
(86) PCT No.: PCT/US20/20051

§ 371 Date: Aug. 25, 2021

Related U.S. Application Data
(60) Provisional application No. 62/811,256, filed on Feb. 27, 2019.

(51) Int. Cl. G06F 40/30; G06F 40/289; G06K 9/62; G06F 16/33; G06N 3/08

(52) U.S. Cl. CPC G06F 40/30; G06F 40/289; G06N 3/08; G06F 16/3334; G06K 9/6215

(57) ABSTRACT

Systems, methods, apparatuses, and computer program products for natural language processing to extract and classify text, and automatically identify information about an entity or institution, are provided. One method may include monitoring, by a computing device, a public network, and automatically ingesting, from the network, content comprising text. The method may also include extracting the text from the content and passing the extracted text as input to a classification model, which processes the text to generate a semantic vector representation of the text and compares the generated semantic vector representation with previously labeled vectors. The method may then include determining a prediction on a meaning of the text based on the result of the comparing step or based on a similarity of the generated vector to other grouped labels of stored vectors, and outputting the prediction of the meaning of the text.

### CROSS-REFERENCE TO RELATED APPLICATIONS

This application claims priority from U.S. provisional patent application No. 62/811,256 filed on Feb. 27, 2019. The contents of this earlier filed application are hereby incorporated by reference in their entirety.

### FIELD

Some example embodiments may generally relate to machine learning or artificial intelligence. For example, certain embodiments may relate to systems and/or methods for natural language processing and/or text recognition and classification.

### BACKGROUND

One application of artificial intelligence or machine learning includes natural language processing. Such natural language processing may include the manner in which computers or devices are programmed to process and analyze large amounts of natural language data. Different types of machine-learning algorithms have been applied to natural language processing tasks. For example, decision tree algorithms produce systems of if-then rules similar to the systems of hand-written rules that were previously applied. Additionally, statistical models can be used, which make soft probabilistic decisions based on attaching weights to each input feature. However, improvements are still needed for extracting certain identifying information from natural language data.

### SUMMARY

An embodiment is directed to a method, which may include monitoring, by a computing device, a network or database, automatically ingesting, from the network or the database, content comprising text, extracting the text from the content and passing the extracted text as input to a classification model, processing the text to generate a semantic vector representation of the text, comparing the generated semantic vector representation with previously labeled vectors, determining a prediction on a meaning of the text based on the result of the comparing step or based on a similarity of the generated vector to other grouped labels of stored vectors, and outputting the prediction of the meaning of the text.

Another embodiment is directed to apparatus that may include at least one processor configured to execute computer program instructions programmed using a predefined set of machine code, and at least one memory configured to store the computer program instructions. The at least one memory and the computer program instructions are configured, with the at least one processor, to cause the apparatus at least to monitor a network or database, automatically ingest, from the network or database, content comprising text, and extract the text from the content. The apparatus may also include a classification model configured to receive the extracted text as input to the classification model, to process the text to generate a semantic vector representation of the text, to compare the generated semantic vector representation with previously labeled vectors, to determine a prediction on a meaning of the text based on the result of the comparing step or based on a similarity of the generated vector to other grouped labels of stored vectors, and to output the prediction of the meaning of the text.

Another embodiment is directed to an apparatus including means for monitoring a public network, means for automatically ingesting, from the network, content comprising text, means for extracting the text from the content and passing the extracted text as input to a classification model, means for processing the text to generate a semantic vector representation of the text, means for comparing the generated semantic vector representation with previously labeled vectors, means for determining a prediction on a meaning of the text based on the result of the comparing step or based on a similarity of the generated vector to other grouped labels of stored vectors, and means for outputting the prediction of the meaning of the text.

Another embodiment is directed to a computer readable medium comprising program instructions stored thereon for executing a process including monitoring, by a computing device, a network or database, automatically ingesting, from the network or the database, content comprising text, extracting the text from the content and passing the extracted text as input to a classification model, processing the text to generate a semantic vector representation of the text, comparing the generated semantic vector representation with previously labeled vectors, determining a prediction on a meaning of the text based on the result of the comparing step or based on a similarity of the generated vector to other grouped labels of stored vectors, and outputting the prediction of the meaning of the text.

### BRIEF DESCRIPTION OF THE DRAWINGS

For proper understanding of example embodiments, reference should be made to the accompanying drawings, wherein:

FIG. 1 illustrates an example system diagram, according to one embodiment;

FIG. 2 illustrates an example flow diagram of a method, according to an embodiment; and

FIG. 3 illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for natural language processing, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or steps discussed below may be performed in a different order and/or concurrently with each other. Furthermore, if desired, one or more of the described functions or steps may be optional or may be combined. As such, the following description should be considered as merely illustrative of the principles and teachings of certain example embodiments, and not in limitation thereof.

Certain embodiments may include a text recognition, classification and/or categorization system and method. For example, some embodiments may be directed to a natural language based processing system and method for identifying information automatically about an institution or entity. In an embodiment, the system may utilize a web firehose to monitor the public internet to ingest news articles and/or websites automatically For example, the news articles and/or websites may be automatically monitored via web crawlers and public or private news APIs.

According to certain embodiments, the firehose may extract the text from the content and may pass the extracted text to a classification model. In one example, the classification model may include an artificial neural network (ANN). During the modeling process, the classification model may first preprocess the text into a semantic vector representation. These vector representations can be generated utilizing techniques including, but not limited to, word2vec, doc2vec, TD-IDF, count vectorization, etc. It is noted that word2vec and doc2vec are examples of models or neural networks that can be used to generate representation vectors from words or text. These vectors can be considered semantic, as text documents that contain the same information will yield similar vectors. The similarity of these vectors may be one input to an iteration of the classification model, which may include a proximity search model (K-Nearest Neighbors is one example).

In one embodiment, the classification model may include an input layer comprising one or more input nodes, one or more hidden layers comprising one or more hidden nodes, and an output layer comprising one or more output nodes. According to an embodiment, each input node may include memory or storage for receiving and storing external data. For example, in an embodiment, the external data may include the extracted text, the semantic vector representation, and/or the similarity of one or more of these semantic vectors.

In an embodiment, the hidden node(s) may be connected to one or more of the input nodes and may include computational instructions (which may be implemented in machine code of a processor) for computing one or more outputs of the hidden node(s). In some embodiments, the output(s) of the hidden node(s) may be inputted to the output node(s) to produce and store an output signal. For example, in one example embodiment, the output signal may include or be indicative of a classification of the extracted text. In an embodiment, the classification of the extracted text may include a semantic vector generated to represent the classification of the text and/or a label reflecting the meaning of the extracted text.

In an embodiment, novel distance functions may be used to compare the generated vector with previously labeled vectors. For example, a vector representation of a company's “Real Estate Services” product page, will have the smallest distance with other “Real Estate Service” product pages from other companies. The similarity of the vector to other grouped labels may yield a prediction on the meaning of the content.

According to an embodiment, content that cannot be classified confidently, i.e., where there are no existing similar examples or there are multiple potential labels, may be sent to a human verification layer. Here, in the human verification layer, a human analyst may provide a correct label for the content. In an embodiment, the correct label provided by the human verification layer may be fed or provided to a database of the classification model to improve predictions or classifications that are output by the classification model.

In one embodiment, the generated vector may then be placed or stored in a database of the classification model, allowing future documents extracted by the firehose to be compared against stored vectors. The labels assigned to a document may be used for many purposes, for example to determine if an operational change has occurred. In this case, the label itself may indicate an operational change, for example in the case where the label is something such as “CEO Retires”. Additionally or alternatively, a comparison of the label to existing data may indicate a change, such as the example of the label indicating the presence of a product offering that was not already present in the database.

Thus, certain embodiments provide a method for representing institutional information in a mathematical vector space. The method may include the steps of converting documents, sourced from the web, into semantic vectors and storing those vectors in a database, as discussed above. According to some embodiments, mathematical operations may be performed on this vector space to allow for the identification of higher order information including but not limited to operational changes, institution similarity, etc.

As a result, some embodiments can be applied for the recognition and classification of text, as well as the detection and/or prediction of events based on the classified text. As discussed above, since example embodiments can yield a prediction on the meaning of content from extracted documents, sites or other information, example embodiments can be configured to provide event detection, such as the detection of an operational or institutional change as one example. It is noted that the detection of other events may also be done using example embodiments described herein, and therefore embodiments of the invention should not be construed to be only limited to the examples discussed herein.

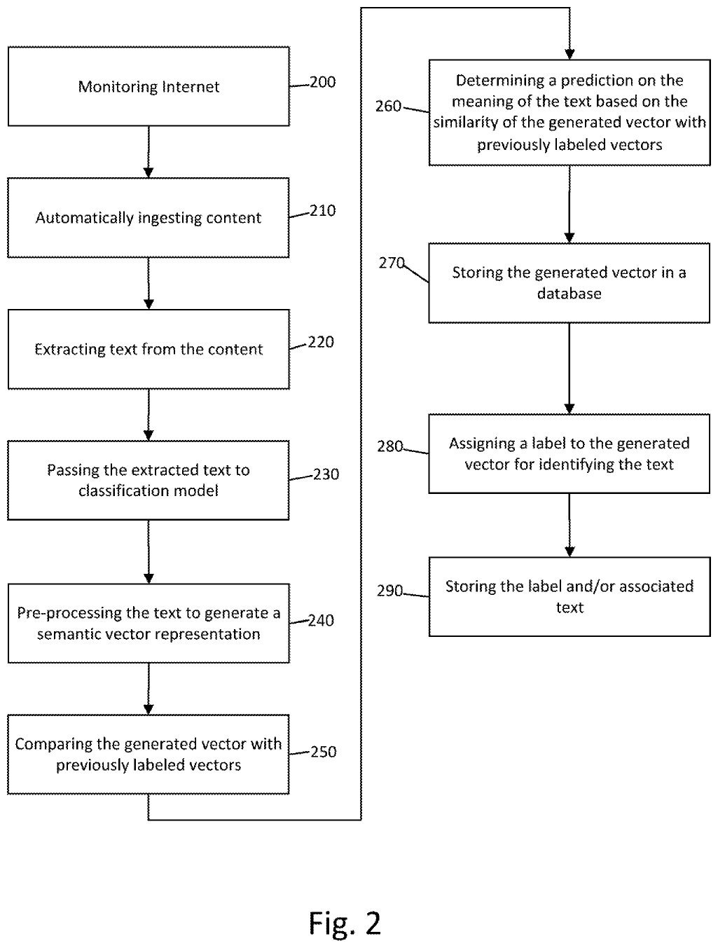

FIG. 2 illustrates an example flow diagram of a method for processing natural language to automatically identify information about an entity, according to an example embodiment. In some example embodiments, the method of FIG. 2 may be performed by a computer system or server including one or more processors and/or one or more memories. It should be noted that the steps depicted in the example flow diagram of FIG. 2 may be performed in a different order than shown herein.

As illustrated in the example of FIG. 2, the method may include, at 200, monitoring the public internet and, at 210, automatically ingesting information or content including, for example, news articles and/or websites. For example, the monitoring 200 may include automatically monitoring the news articles and/or websites via web crawlers and public or private news APIs.

According to certain embodiments, the method may also include, at 220, extracting text from the content and, at 230, passing the extracted text to a classification model. In an embodiment, the method may then include, at 240, pre-processing the text to generate a semantic vector representation. For example, the pre-processing may include generating the vector representations utilizing techniques such as, but not limited to, word2vec, doc2vec, TD-IDF, count vectorization, etc. These vectors may be considered semantic, because text documents that contain the same information will yield similar vectors. According to one embodiment, the classification model may be a proximity search model (e.g., K-Nearest Neighbors model).

In an embodiment, the method may also include, at 250, comparing the generated vector with previously labeled vectors, for example, using novel distance functions. As one example, a comparison of a vector representation of a company's “Real Estate Services” product page, will have the smallest distance with other “Real Estate Service” product pages from other companies. According to some embodiments, the method may also include, at 260, determining and/or outputting a prediction on the meaning of the text based the result of the comparison step 250 and/or based on the similarity of the vector to other grouped labels of stored vectors. For example, in some embodiments, the outputting may include outputting the prediction to a display, user device, or to another model or network node for further processing.

According to an embodiment, if content cannot be classified confidently, i.e., where there are no existing similar examples or there are multiple potential labels, the method may include sending the text to a human verification layer. In this example, in the human verification layer, a human analyst may provide a correct label for the content. In an embodiment, the correct label from the human verification layer may then be provided to one or more nodes of the classification model or to the database of the classification model to improve and/or assist in current or future predictions.

In one embodiment, the method may include, at 270, storing the generated vector in a database of the classification model, which allows future text or documents to be compared against it. According to certain embodiments, the method may include, at 280, assigning a label to the generated vector or extracted text for purposes of identifying the text. As one example, the label may be used to determine if an operational change has occurred. In this case, the label itself may indicate an operational change, for example in the case where the label is something such as “CEO Retires”. Additionally or alternatively, a comparison of the label to existing data may indicate a change, such as the example of the label indicating the presence of a product offering that was not already present in the database. In one embodiment, the method may also include, at 290, storing the label and/or associated text in the database or memory.

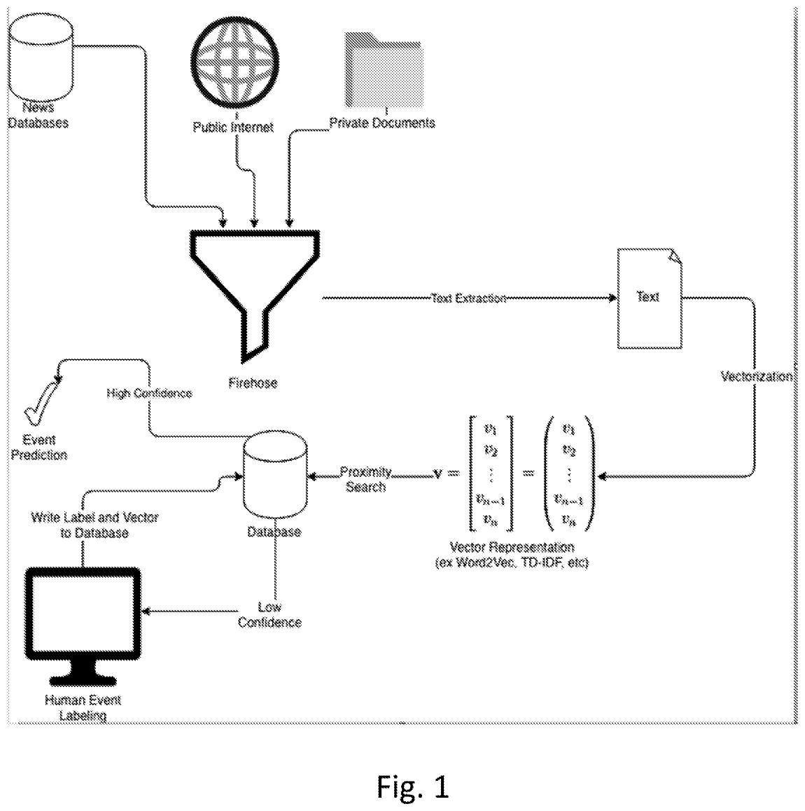

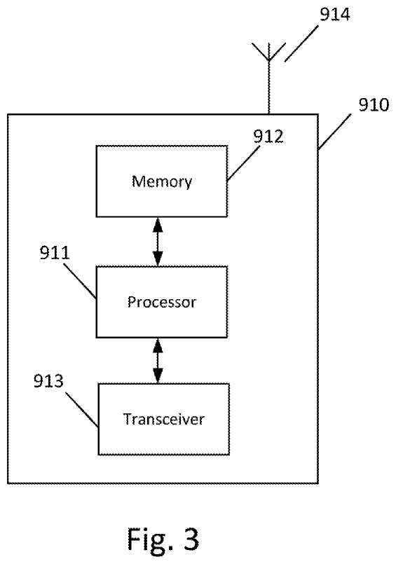

FIG. 3 illustrates an example block diagram of an apparatus 910, according to certain example embodiments. In the example of FIG. 3, apparatus 910 may include, for example, a computing device or server. Certain embodiments may include more than one computing device or server, although only one is shown for the purposes of illustration. The apparatus 910 may be included in system 100 of FIG. 1 or vice versa.

In an embodiment, apparatus 910 may include at least one processor or control unit or module, indicated as 911 in the example of FIG. 3. Processor 911 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

According to an embodiment, apparatus 910 may also include at least one memory 912. Memory 912 may be any suitable storage device, such as a non-transitory computer-readable medium. For example, memory 912 may be a hard disk drive (HDD), random access memory (RAM), flash memory, or other suitable memory may be used. The memory 912 may include or store computer program instructions or computer code contained therein. In some embodiments, apparatus 910 may include one or more transceivers 913 and/or an antenna 914. Although only one antenna each is shown, many antennas and multiple antenna elements may be provided. Other configurations of apparatus 910 may be provided. For example, apparatus 910 may be additionally configured for wired or wireless communication. In some examples, antenna 914 may illustrate any form of communication hardware, without being limited to merely an antenna.

Transceiver 913 may be a transmitter, a receiver, or both a transmitter and a receiver, or a unit or device that may be configured both for transmission and reception. The operations and functionalities may be performed in different entities, such as nodes, hosts or servers, in a flexible manner.

The apparatus 910 may be any combination of hardware that includes at least a processor and a memory. For example, the computing device may include one or more servers (e.g., application server, web server, file server or the like), and/or one or more computers or computing devices. In some embodiments, the computing device may be provided with wireless capabilities.

In certain embodiments, apparatus 910 may include means for carrying out embodiments described above in relation to FIG. 1 or 2. In certain embodiments, at least one memory including computer program code can be configured to, with the at least one processor, cause the apparatus at least to perform any of the processes or embodiments described herein. For instance, in one embodiment, memory 912 may store one or more of the models illustrated in FIG. 1 for execution by processor 911. According to certain embodiments, memory 912 including computer program code may be configured, with the processor 911, to cause the apparatus 910 at least to perform the method of FIG. 2.

In an embodiment, apparatus 910 may be controlled by memory 912 and processor 911 to monitor a network (e.g., a public/private network or Internet) or database and to automatically ingest, from the network, information or content comprising text. In certain embodiments, the text may be automatically ingested from sources on the network, such as news articles or websites. According to an embodiment, when monitoring the public network, apparatus 910 may be controlled by memory 912 and processor 911 to automatically monitor the news articles or websites via web crawlers and public or private news application programming interfaces (APIs). Apparatus 910 may then be controlled by memory 912 and processor 911 to extract the text from the content and to pass the extracted text to a classification model, which may be stored in memory 912. According to some embodiments, the classification model may include an artificial neural network and/or a proximity search model.

According to certain embodiments, the classification model may be configured to receive the extracted text as input, process the text to generate a semantic vector representation of the text, compare the generated semantic vector representation with previously labeled vectors, determine a prediction on a meaning of the text based on the result of the comparing step or based on a similarity of the generated vector to other grouped labels of stored vectors, and output the prediction of the meaning of the text.

In an embodiment, to generate the semantic vector representation, apparatus 910 may be controlled by memory 912 and processor 911 to generate the vector representation utilizing at least one of a word2vec model, doc2vec model, term frequency-inverse document frequency (TF-IDF), or count vectorization. According to one embodiment, apparatus 910 may be controlled by memory 912 and processor 911 to compare the generated vector with previously labeled vectors using distance functions to determine a similarity between the generated vector and the previously labeled vectors. In some embodiments, apparatus 910 may be controlled by memory 912 and processor 911 to store the generated vector in a database or memory of the classification model to allow future text or documents to be compared against the stored vectors.

According to an embodiment, apparatus 910 may be further controlled by memory 912 and processor 911 to assign a label to the generated vector or extracted text, wherein the label comprises an identification of the text. In one embodiment, the label and/or associated text may be stored in the database or memory.

Therefore, certain example embodiments provide several technical improvements, enhancements, and/or advantages. Certain embodiments provide methods for improving the accuracy and efficiency of machine learning algorithms or models running on a computer system. For example, certain embodiments improve the ability and accuracy of machines or computers to process natural language to determine, identify and label relevant content. Accordingly, the use of certain example embodiments results in a technical improvement to computer functionality.

In some example embodiments, the functionality of any of the methods, processes, signaling diagrams, algorithms or flow charts described herein may be implemented by software and/or computer program code or portions of code stored in memory or other computer readable or tangible media, and executed by a processor.

In some example embodiments, an apparatus may be included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and include program instructions to perform particular tasks.

A computer program product may comprise one or more computer-executable components which, when the program is run, are configured to carry out some example embodiments. The one or more computer-executable components may be at least one software code or portions of it. Modifications and configurations required for implementing functionality of an example embodiment may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 910), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the example embodiments as discussed above may be practiced with steps in a different order, and/or with hardware elements in configurations which are different than those which are disclosed. Therefore, although some embodiments have been described based upon these example preferred embodiments, it would be apparent to those of skill in the art that certain modifications, variations, and alternative constructions would be apparent, while remaining within the spirit and scope of example embodiments.

1. A method, comprising:
monitoring, by a computing device, a network or database;
automatically ingesting, from the network or the database, content comprising text,
extracting the text from the content and passing the extracted text as input to a classification model;
processing the text to generate a semantic vector representation of the text;
comparing the generated semantic vector representation with previously labeled vectors;
determining a prediction on a meaning of the text based on the result of the comparing step or based on a similarity of the generated vector to other grouped labels of stored vectors; and
outputting the prediction of the meaning of the text.

2. The method according to claim 1, wherein the text is automatically ingested from news articles or websites.

3. The method according to claim 2, wherein the monitoring comprises automatically monitoring the news articles or websites via web crawlers and public or private news application programming interfaces (APIs).

4. The method according to claim 1, wherein the processing comprises generating the vector representation utilizing at least one of a word2vec model, doc2vec model, term frequency-inverse document frequency (TF-IDF), or count vectorization.

5. The method according to claim 1, wherein the classification model comprises at least one of an artificial neural network and a proximity search model.

6. The method according to claim 1, wherein the comparing comprises comparing the generated vector with previously labeled vectors using distance functions to determine a similarity between the generated vector and the previously labeled vectors.

7. The method according to claim 1, further comprising storing the generated vector in a database or memory of the classification model to allow future text or documents to be compared against the stored vectors.

8. The method according to claim 1, further comprising assigning a label to the generated vector or extracted text, wherein the label comprises an identification of the text.

9. The method according to claim 8, further comprising storing the label and/or associated text in the database or memory.

10. An apparatus, comprising:
at least one processor configured to execute computer program instructions programmed using a predefined set of machine code;
at least one memory configured to store the computer program instructions;
wherein the at least one memory and the computer program instructions are configured, with the at least one processor, to cause the apparatus at least to:
monitor a network or database,
automatically ingest, from the network or database, content comprising text, and
extract the text from the content; and
a classification model configured to:
receive the extracted text as input to the classification model,
process the text to generate a semantic vector representation of the text,
compare the generated semantic vector representation with previously labeled vectors,
determine a prediction on a meaning of the text based on the result of the comparing step or based on a similarity of the generated vector to other grouped labels of stored vectors, and
output the prediction of the meaning of the text.

11. The apparatus according to claim 10, wherein the text is automatically ingested from news articles or websites.

12. The apparatus according to claim 11, wherein, when monitoring the network, the at least one memory and the computer program instructions are configured, with the at least one processor, to cause the apparatus at least to automatically monitor the news articles or websites via web crawlers and public or private news application programming interfaces (APIs).

13. The apparatus according to claim 10, wherein, to generate the semantic vector representation, the at least one memory and the computer program instructions are configured, with the at least one processor, to cause the apparatus at least to generate the vector representation utilizing at least one of a word2vec model, doc2vec model, term frequency-inverse document frequency (TF-IDF), or count vectorization.

14. The apparatus according to claim 10, wherein the classification model comprises at least one of an artificial neural network and a proximity search model.

15. The apparatus according to claim 10, wherein the at least one memory and the computer program instructions are configured, with the at least one processor, to cause the apparatus at least to compare the generated vector with previously labeled vectors using distance functions to determine a similarity between the generated vector and the previously labeled vectors.

16. The apparatus according to claim 10, wherein the at least one memory and the computer program instructions are further configured, with the at least one processor, to cause the apparatus at least to store the generated vector in a database or memory of the classification model to allow future text or documents to be compared against the stored vectors.

17. The apparatus according to claim 10, wherein the at least one memory and the computer program instructions are further configured, with the at least one processor, to cause the apparatus at least to assign a label to the generated vector or extracted text, wherein the label comprises an identification of the text.

18. The apparatus according to claim 17, wherein the at least one memory and the computer program instructions are further configured, with the at least one processor, to cause the apparatus at least to store the label and/or associated text in the database or memory.

19. An apparatus, comprising:
means for monitoring a public network;
means for automatically ingesting, from the network, content comprising text,
means for extracting the text from the content and passing the extracted text as input to a classification model;
means for processing the text to generate a semantic vector representation of the text;
means for comparing the generated semantic vector representation with previously labeled vectors;
means for determining a prediction on a meaning of the text based on the result of the comparing step or based on a similarity of the generated vector to other grouped labels of stored vectors; and
means for outputting the prediction of the meaning of the text.

20. A computer readable medium comprising program instructions stored thereon for performing at least the method according to claim 1.
